(19) United States
(12) Patent Application Publication
(10) Pub. No.: US 2009/0181290 A1
(43) Pub. Date: Jul. 16, 2009

(54) System and Method for an Automated Battery Arrangement

(76) Inventors: Travis Baldwin, Dix Hills, NY (US); Robert Spano, Smithtown, NY (US)

Correspondence Address: MOTOROLA, INC., 1303 EAST ALGONQUIN ROAD, IL01/3RD, SCHAUMBURG, IL, 60196, US

(21) Appl. No.: 12/013,701

(22) Filed: Jan. 14, 2008

(51) Int. Cl. H01M 2/10

(52) U.S. Cl. 429/100

(57) ABSTRACT

An electronic device comprises a housing and a battery arrangement. The housing has a recess which is shaped to receive a removable battery. The battery arrangement includes a locking mechanism automatically securing the battery within the recess from an initial position into a final position. The battery arrangement prevents a removal of the battery until a powering down procedure of the device is completed.

### FIELD OF THE INVENTION

The present invention relates generally to a system and method for an automated battery arrangement. Specifically, the battery arrangement is used for detection, insertion, retention, and ejection of a battery.

### BACKGROUND

Portable devices often utilize a removable power source (e.g., a battery, a capacitor, a supercapacitor, etc.) to provide the necessary energy to operate the device. The power source establishes an electrical connection to the device to supply the energy. The electrical connection may be established using, for example, a plurality of electrical contact points (e.g., pins) present on the device that couples to a corresponding plurality of electrical contact points on the power source. However, if the battery is improperly placed in the device, the energy may not be supplied to the device as no electrical connection is established. For example, if even one of the plurality of electrical contact points does not couple properly, the electrical connection may not exist. Errors in placement of the power source in the device may cause this problem.

Often, users properly shut down the device prior to removal of the battery. However, the portable nature of the device causes the battery to be inadvertently removed. In addition, the battery may be jarred loose, disconnecting the battery from the device. A user may also purposely remove the battery without properly shutting the device down. The improper removal of the battery causes data to become lost or corrupted. Though some portable devices incorporate a back-up power supply, an abrupt removal of a battery creates a gap in the supplying of power.

### SUMMARY OF THE INVENTION

The present invention relates to an electronic device comprising a housing and a battery arrangement. The housing has a recess which is shaped to receive a removable battery. The battery arrangement includes a locking mechanism automatically securing the battery within the recess from an initial position into a final position. The battery arrangement prevents a removal of the battery until a powering down procedure of the device is completed.

### DESCRIPTION OF THE DRAWINGS

FIG. 1a shows a mobile unit according to an exemplary embodiment of the present invention.

FIG. 1b shows a battery that couples to the mobile unit of FIG. 1 according to an exemplary embodiment of the present invention.

FIG. 2 shows a first latching scheme according to an exemplary embodiment of the present invention.

FIG. 3 shows a second latching scheme according to an exemplary embodiment of the present invention.

FIG. 4 shows a third latching scheme according to an exemplary embodiment of the present invention.

FIG. 5a shows a method for automatically detecting, inserting, and retaining a battery according to an exemplary embodiment of the present invention.

FIG. 5b shows a method for ejecting a battery according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe an automated battery arrangement for a mobile unit (MU). The automated battery arrangement may be used for detection, insertion, retention, and ejection of a battery. The MU, the automated battery arrangement, and an associated method will be discussed in more detail below. It should be noted that the term “battery” in the following description may refer to any device that stores energy and provides the energy to a device. It should also be noted that the use of the MU is only exemplary. The exemplary embodiments of the present invention may apply to any electronic device which has a removable battery.

An MU may be equipped with a battery retention arrangement so that the battery is securely placed in a recess of the MU. However, the battery retention arrangement may not provide other features necessary for providing power to the MU. In a first example, a reliable contact between the battery and MU is important so that energy may be drawn from the battery whenever necessary. In a second example, a one-handed insertion and removal of the battery may provide an efficient means of using the MU. In a third example, a high durability may provide rugged use of the MU as the MU is portable and subject to various environments. In a fourth example, accommodation to allow the MU to shut down properly prior to battery removal prevents corruption or loss of data. In a fifth example, occupying a minimal amount of space may provide a design of the MU to be small and light weight. In a sixth example, resistance to improper assembly may provide that an electrical connection between the battery and the MU is properly established. All these examples enable a proper usage of the battery with the MU and may, for example, prevent damage to the MU in a physical sense (e.g., breakage) and in a software sense (e.g., corruption).

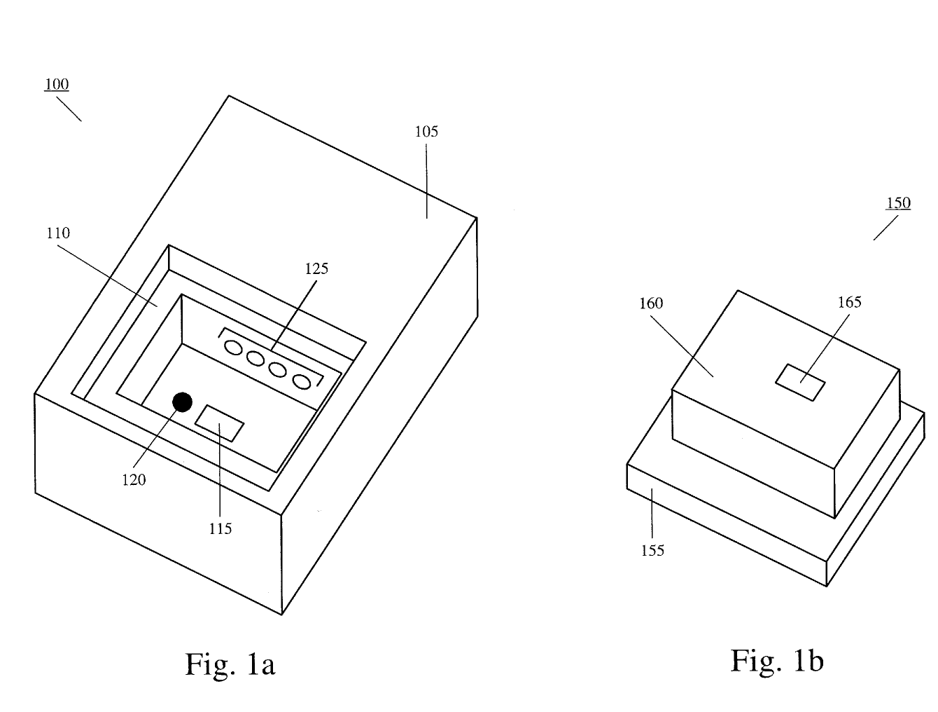

FIGS. 1a-b shows an MU 100 and a battery 150 according to an exemplary embodiment of the present invention. The MU 100 may be any electronic device (e.g., portable or stationary) that utilizes an exclusive or non-exclusive source of power such as the battery 150. For example, the MU 100 may be a mobile computer, a personal digital assistant (PDA), a laptop, a pager, a cell phone, a data acquisition device (e.g., a radio frequency identification reader, a scanner, an image capturing device, etc.), etc. The MU 100 may include a housing 105, a recess 110, a locking mechanism 115, a sensor 120, and contacts 125. The battery 150 may be any portable power supply providing power to the MU 100. For example, the battery 150 may be a rechargeable battery (e.g., NiCd, LiH, Li Ion, etc.), a capacitor, a supercapacitor, etc. The battery 150 may be assembled with the MU 100 as a single unit. The battery 150 may include a cover 155, a battery housing 160, a corresponding locking mechanism 165, and corresponding contacts (not shown).

The housing 105 may provide a casing in which components of the MU 100 may be at least partially disposed. That is, the components of the MU 100 may be wholly or partially within the housing 105. For example, the MU 100 may include a processor, a memory, a transceiver, etc. These components may be fragile and, therefore, be entirely disposed within the housing 105. In another example, the MU 100 may include a display, a data input arrangement (e.g., keypad), a scanner, etc. that may be disposed partially within the housing 105 so that a portion of these components are disposed on a periphery of the housing 105.

The recess 110 may be a space in the housing 105 in which the battery 150 is received. That is, according to the exemplary embodiments of the present invention, when assembled, the battery 150 is disposed within a periphery of the overall MU 100. The recess 110 may be configured so that the battery 150 is properly placed therein, thereby preventing an improper reception of the battery 150. For example, as illustrated in FIG. 1, the recess 110 may include a plurality of levels (e.g., a first level and a second level). The second level may house the battery 150 while the first level may house a cover or lid.

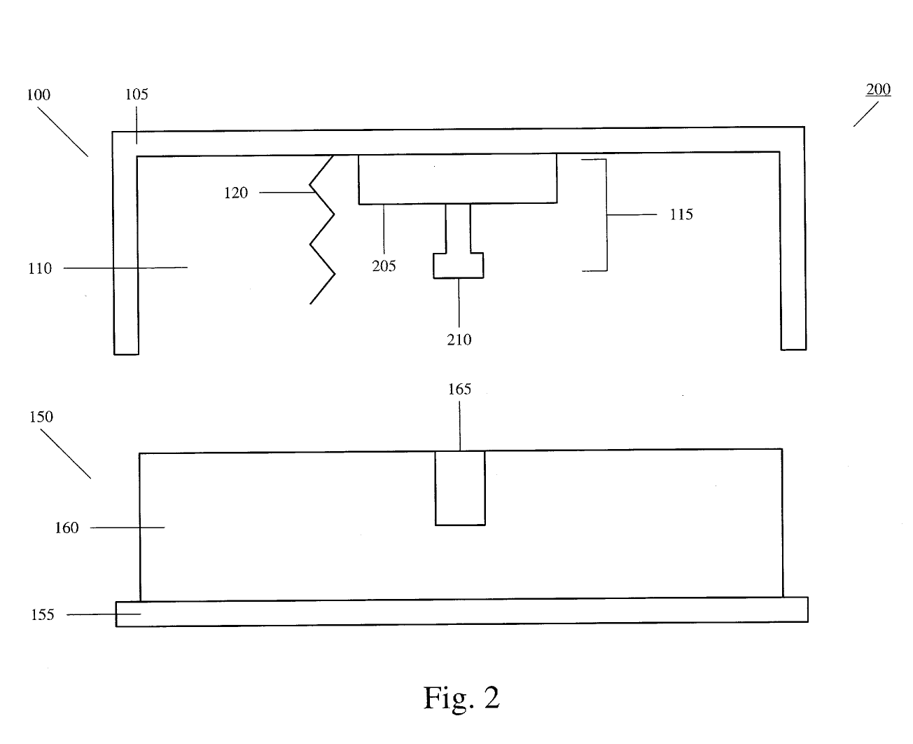

The locking mechanism 115 may provide for a secure retention of the battery 150 when assembled with the MU 100. According to the exemplary embodiments of the present invention, the locking mechanism 115 may be a stepper motor assembly, an electric motor assembly, and a solenoid. The different exemplary embodiments of the locking mechanism 115 will be described in further detail below with reference to FIGS. 2-4.

The sensor 120 may provide data to a processor of the MU 100 indicative of when the battery 150 is to be received within the recess 110. The sensor 120 may be any device capable of detecting when the battery 150 has been at least partially received in the recess 110. For example, the sensor 120 may be a spring sensor. The spring sensor may extend from the recess 110. When the battery 150 is received at least partially within the recess 110, the spring sensor may be activated (e.g., by being depressed). The spring sensor may then provide data to the processor. The spring sensor may be sensitive to recognize an amount in which the battery 150 has already been received in the recess 110. Thus, the spring sensor may also provide this data to the processor. The sensor 120 may also be, for example, a light sensor, an image sensor, etc.

The contacts 125 may be a plurality of contacts used to electrically couple the battery 150 with the MU 100. Specifically, the contacts 125 may provide an electrical connection in which power from cells of the battery 150 may travel to the MU 100. The contacts 125 may be, for example, pins extending out of the housing 105, flat contacts disposed on a periphery of the housing 105, pinholes extending into the housing 105, coil springs, leaf springs, pogo pins, conductive pads, torsional springs, etc. The contacts 125 may be manufactured of a conducting material such as beryllium copper, silver, gold, etc. As illustrated, the contacts 125 may include four contacts and be disposed within the recess 110. It should be noted that the use of four contacts is only exemplary and the contacts 125 may include fewer or more contacts.

The cover 155 may be part of an overall housing of the assembled unit. Specifically, the cover 155 may be disposed over the recess 110 of the MU 100. The cover 155 and the housing 105 may create a flush exterior when the MU 100 is assembled with the battery 150. As will be explained in detail below, the cover 155 may not require a spring latch that is found in conventional covers for conventional MUs. However, the exemplary embodiments of the present invention may include the spring latch.

The battery housing 160 may provide a casing in which components of the battery 150 may be disposed therein. The battery housing 160 may be substantially similar to the housing 105 of the MU 100. Those skilled in the art will understand that the battery 150 includes a plurality of cells that store energy. The cells may be disposed within the battery housing 160. The battery housing 160 may also be a site where the corresponding contacts are disposed. The cells within the battery housing 160 may be coupled to the corresponding contacts so that when the corresponding contacts couple with the contacts 125, the electrical connection is established.

The corresponding locking mechanism 165 may be a complementary component with the locking mechanism 115. Thus, the corresponding locking mechanism 165 may also provide for a secure retention of the battery 150 when assembled with the MU 100. According to the exemplary embodiments of the present invention, the corresponding locking mechanism 165 may be complementary to when the locking mechanism 115 is a stepper motor assembly, an electric motor assembly, and a solenoid. The different exemplary embodiments of the corresponding locking mechanism 165 will be described in further detail below with reference to FIGS. 2-4.

FIG. 2 shows a first latching scheme 200 according to an exemplary embodiment of the present invention. FIG. 2 illustrates a cross sectional view of the first latching scheme 200. The first latching scheme 200 includes the locking mechanism 115 that may be a step motor 205 and a quarter turn mechanism 210. Accordingly, the corresponding locking mechanism 165 may be a quarter turn receptacle.

When the battery housing 160 of the battery 150 is received in the recess 110 of the MU 100, the sensor 120 may be triggered. The sensor 120 may indicate that the battery 150 has been at least partially received. The sensor 120 may provide data to the processor of the MU 100 indicating when the first latching scheme 200 is to be used. For example, when the battery housing 160 has been received in the recess 110 at a point where an end of the quarter turn mechanism 210 meets an end of the quarter turn receptacle, the step motor 205 may be activated.

Upon activation, the step motor 205 may turn the quarter turn mechanism 210. The quarter turn mechanism 210 and the quarter turn receptacle may couple and continuous turns from the step motor 205 may draw the battery 150 into the recess 110 until secure. The processor may be aware of when the battery 150 is secured in the recess 110 utilizing the sensor 120 or other sensors disposed in the locking mechanism 115, in the recess 110, etc.

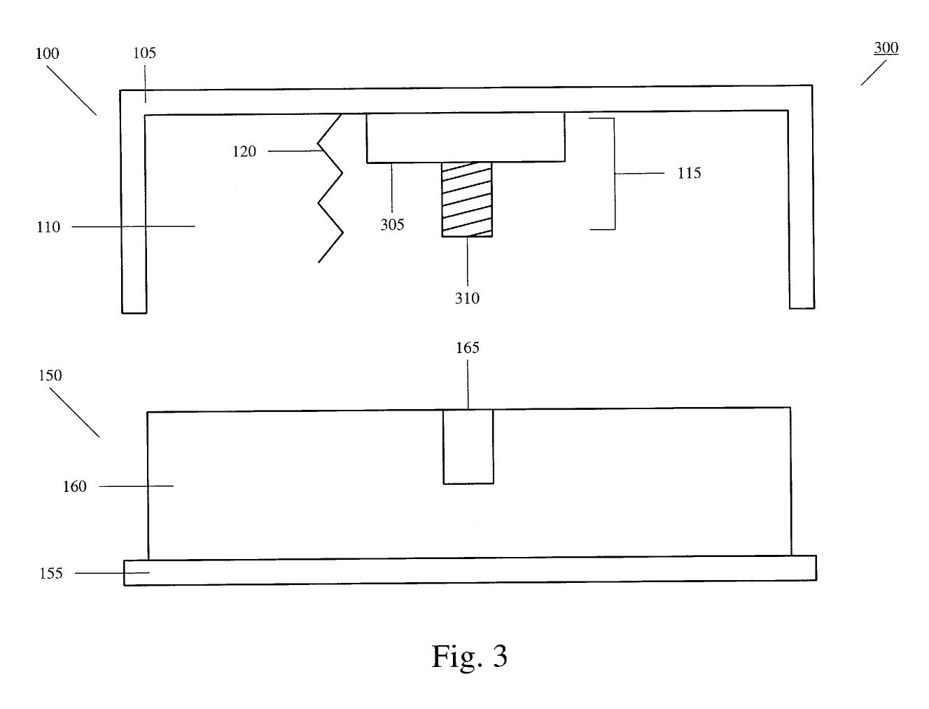

FIG. 3 shows a second latching scheme 300 according to an exemplary embodiment of the present invention. FIG. 3 illustrates a cross sectional view of the second latching scheme 300. The second latching scheme 300 includes the locking mechanism 115 that may be an electric motor 305 and a machine screw thread 310. Accordingly, the corresponding locking mechanism 165 may be a threaded insert.

The sensor 120 may function in a substantially similar manner as discussed above with the first latching scheme 200. Thus, the sensor 120 provides the data to the processor of the MU 100 indicating when the second latching scheme 300 is to be used. Upon activation, the electric motor 305 may turn the machine screw thread 310 continuously. The machine screw thread 310 and the threaded insert may couple and continuous turns from the electric motor 305 may draw the battery 150 into the recess 110 until secure. The processor may be aware of when the battery 150 is secured in the recess 110 utilizing the sensor 120 or other sensors disposed in the locking mechanism 115, in the recess 110, etc.

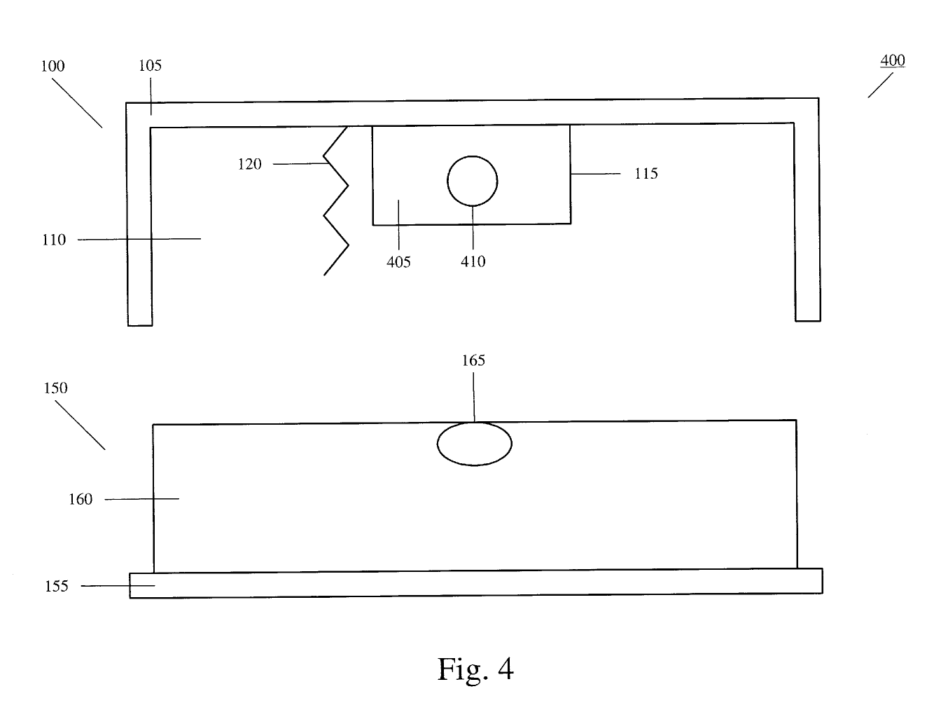

FIG. 4 shows a third latching scheme 400 according to an exemplary embodiment of the present invention. FIG. 4 illustrates a cross sectional view of the third latching scheme 400. The third latching scheme 400 includes the locking mechanism 115 that may be a solenoid 405 and a locking pin 410. Accordingly, the corresponding locking mechanism 165 may be a locking pin groove.

The sensor 120 may function in a substantially similar manner as discussed above with the first latching scheme 200. Thus, the sensor 120 provides the data to the processor of the MU 100 indicating when the third latching scheme 400 is to be used. Upon activation, the solenoid 405 may adjust a position of the locking pin 410. The locking pin 410 and the locking pin groove may couple and continuous adjustments from the solenoid 405 may provide a secure assembly of the battery 150 with the MU 100. The processor may be aware of when the battery 150 is secured in the recess 110 utilizing the sensor 120 or other sensors disposed in the locking mechanism 115, in the recess 110, etc.

Using any of the exemplary embodiments described above with reference to FIGS. 2-4, the battery 150 may be properly assembled with the MU 100. Specifically, the contacts 125 may be coupled to the corresponding contacts of the battery 150 so that an electrical connection is established. One of the advantages of the exemplary embodiments of the present invention is removing a human element from the operation and, thus, substantially decreasing errors in entry and reception of the battery 150 in the recess 110, thereby also reducing accidents and damage. Furthermore, upon proper reception of the battery 150, the battery 150 is retained in an operating position so that energy from the battery 150 may be drawn whenever necessary.

It should be noted that the MU 100 may be configured so that the battery 150 may be used for the automated battery arrangement. For example, contacts disposed on the locking mechanism 115 and on the corresponding locking mechanism 165 may couple so that an immediate powering of the MU 100 may take place. This powering of the MU 100 may include the energy to operate the automated battery arrangement. The coupling of the locking mechanism contacts may provide a temporary powering or may further serve as a backup powering site. That is, the coupling of the contacts 125 with the corresponding contacts of the battery 150 may be a primary powering site when the battery 150 is in a proper orientation in the recess 110 of the MU 100.

In addition, the locking mechanism 115 and the corresponding locking mechanism 165 may provide for proper retention of the battery 150 prior to any removal (e.g., purposeful or inadvertent) or jarring. The processor may control the locking mechanism 150 so that a removal of the battery 150 is completely prevented until a powering down procedure (e.g., proper shut down) of the MU 100 is first performed. Thus, data may be properly saved and no corruption or loss occurs. The processor may also activate a timer where the timer is of an adequate amount for the MU 100 is to be properly powered down. The processor may further use the locking mechanism 115 to fix the position of the battery 150 when the battery 150 becomes loose (e.g., from jarring). The sensor 120 or other component may monitor the position of the battery 150 and send data to the processor indicating the position. When the position of the battery 150 falls outside of acceptable parameters, the processor may activate the locking mechanism 115 to adjust the position of the battery 150.

It should be noted that the MU 100 may be equipped with a manual access to eject the battery 150. For example, when no power is available to remove the battery 150 or the system (e.g., processor) of the MU 100 crashes, the battery 150 may be required to be manually ejected. An emergency pin head button, access to rotate motors with a preconfigured tool, and/or other method suitable to the latching method may be disposed so that a manual release of the locking mechanism 115 is performed, thereby ejecting the battery 150 from the recess 110.

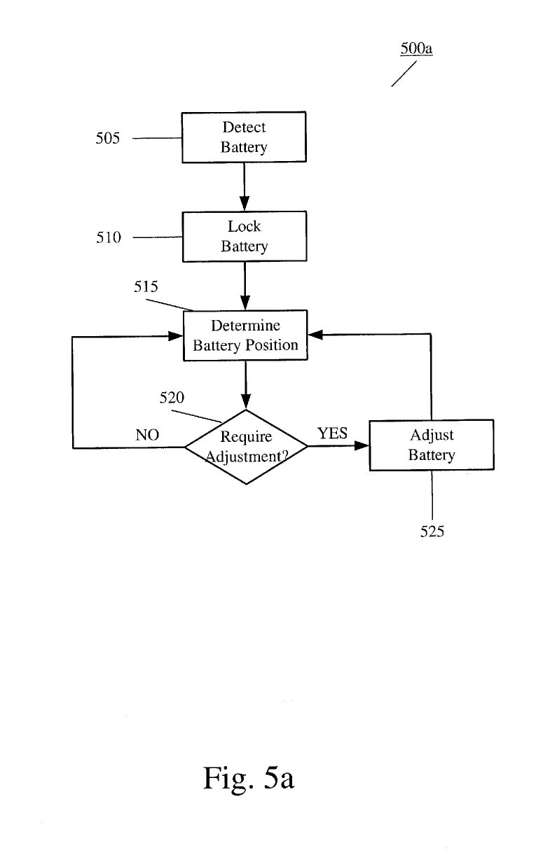

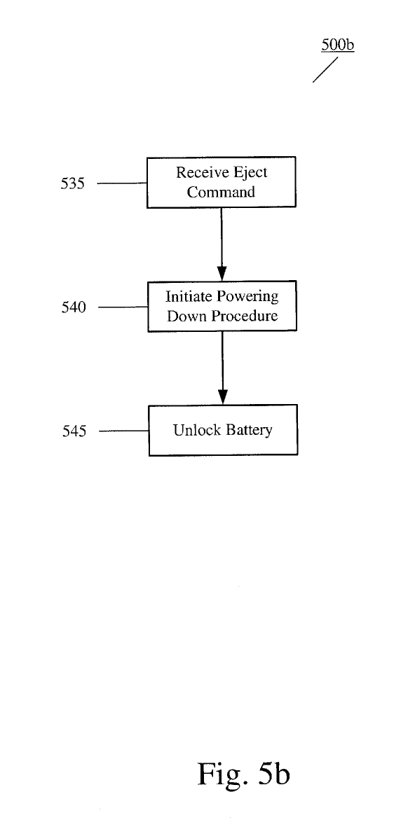

FIG. 5a shows a method 500a for automatically detecting, inserting, and retaining a battery according to an exemplary embodiment of the present invention. The method 500 describes a first set of the different aspects performed by the exemplary embodiments of the automated battery arrangement described above. Thus, the method 500 will be described with reference to the exemplary embodiments of FIGS. 1-4.

In step 505, the battery 150 is detected in the recess 110. It may be assumed that the battery 150 has been at least partially received in the recess 110. It should be noted that the battery 150 is not required to be completely received within the recess 110. According to the exemplary embodiments of the present invention, the battery 150 may be received in the recess 110 at least to a predetermined point (i.e., an initial position) where the sensor 120 recognizes that an insertion process has been initiated. For example, when the sensor 120 is a spring sensor, the battery 150 may be inserted until the battery 150 (specifically, the battery housing 160) contacts the sensor 120. In another example, when the sensor 120 is a light sensor, the battery 150 may merely be located at a predetermined distance that the light path is disrupted (or reflected).

As discussed above, the sensor 120 detects a presence of the battery 150 within the recess 110. The detection of the battery 150 may indicate to the processor of the MU 100 that the battery 150 is to be received and the unit is to be assembled. Thus, the processor may initiate the automated battery arrangement.

In step 510, the battery 150 is locked. Once the automated battery arrangement has been activated (i.e., the battery 150 is in the initial position), the locking mechanism 115 may perform the locking function to retain the battery within the recess 110. As described above, the locking mechanism 115 may comprise of different components, depending on the type of latching scheme. In the first exemplary embodiment where the locking mechanism 115 includes the step motor 205 and the quarter turn mechanism 210, the step motor 205 may rotate in intervals until the battery 150 has been secured. In the second exemplary embodiment where the locking mechanism 115 includes the electric motor 305 and the machine screw thread 310, the electric motor 205 may continuously rotate until the battery 150 has been secured. In the third exemplary embodiment where the locking mechanism 115 includes the solenoid 405 and the locking pin 410, the solenoid 405 may continuously adjust the locking pin 410 until the battery 150 has been secured.

Thus, once the locking mechanism 115 performs its respective function, the battery 150 may be moved from the initial position into a final position. The final position may be an optimal location for the battery 150. For example, the final position may entail the set of contacts 125 of the MU 100 being aligned with the corresponding set of contacts of the battery 150.

In step 515, a position of the battery 150 is determined. Specifically, upon detecting the battery 150 (e.g., step 505) and locking the battery 150 (e.g., step 510), the determination may be used to ascertain whether the battery 150 has been properly received in the recess 110. The determination may also be used to indicate whether the position of the battery 150 has been altered from the final position. The altered position may be created, for example, during the course of use of the MU 100. The battery 150 may become loose or change position, thereby potentially disrupting the coupling of the set of contacts 125 with the corresponding set of contacts.

In step 520, a checking procedure is initiated to determine if an adjustment procedure should be activated. The adjustment may be a check to indicate whether the battery 150 has been properly received in the recess, secured and locked in the recess, established an electrical connection between the MU 100 and the battery 150, etc. The determination for an adjustment may also be a continuous check performed throughout a use of the MU 100. That is, during the course of use, if the battery 150 were to become loose or an ideal position of the battery 150 is lost, the determination may again be made. Thus, an adjustment of the battery 520 may be performed in step 525 when the battery 150 has not been properly received in the recess 110, the battery 150 has become loose during use, etc. For example, the step motor 205 may rotate a number of intervals in either direction; the electric motor 305 may rotate accordingly in either direction; and the solenoid 405 may adjust the locking pin 410 accordingly. Whether the battery 150 does not require adjustment or the battery 150 is adjusted, the battery 150 is in a final position so that the battery is properly oriented to supply power to the MU 100. The method 500 returns to step 515 to make further determinations of the position of the battery 150 while the MU 100 is in use.

FIG. 5b shows a method 500b for automatically ejecting a battery according to an exemplary embodiment of the present invention. The method 500 describes a second set of the different aspects performed by the exemplary embodiments of the automated battery arrangements described above. Thus, the method 500 will be described with reference to the exemplary embodiments of FIGS. 1-4.

In step 535, a command to eject the battery 150 is received. The processor of the MU 100 may receive the command. The command may be sent to the processor upon a trigger being activated. For example, a key on the housing 105 may be disposed so that when pressed, the command is generated. In another example, an operating system of the MU 100 may include a command that is initiated to generate the eject command.

In step 540, a powering down procedure (e.g., proper shut down) is activated. As discussed above, a premature removal of the battery 150 may cause data to be corrupted and/or lost. The premature removal of the battery 150 may also cause damage to the MU 100. Once the MU 100 has been properly powered down, the method 500b continues to step 545 where the battery 150 is unlocked. For example, a reverse action from that taken in step 515 of the method 500a (i.e., locking the battery 150) may take place so that the battery 150 is unlocked and may, therefore, be removed (e.g., ejected).

It should be noted that in another exemplary embodiment, the MU 100 may include a secondary power supply within the housing 105. The secondary power supply may also be a battery, a capacitor, a supercapacitor, etc. The secondary power supply may be used for operating the automated battery arrangement prior to reception of the battery 150. The secondary power supply may be recharged after reception of the battery 150, separately recharged using a charging device, etc. Thus, the battery 150 may not be required to provide the power to operate the automated battery arrangement.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An electronic device, comprising:
a housing having a recess which is shaped to receive a removable battery; and
a battery arrangement including a locking mechanism automatically securing the battery within the recess from an initial position into a final position, the battery arrangement preventing a removal of the battery until a powering down procedure of the device is completed.

2. The electronic device of claim 1, further comprising:
a sensor disposed within the recess determining when the battery is in the initial position.

3. The electronic device of claim 2, wherein the sensor is configured to activate the battery arrangement when the battery is in the initial position.

4. The electronic device of claim 2, wherein the sensor is one of a spring sensor and a light sensor.

5. The electronic device of claim 1, wherein the locking mechanism includes one of a quarter turn mechanism, a machine thread insert, and a locking pin.

6. The electronic device of claim 5, wherein, when the locking mechanism includes the quarter turn mechanism, a step motor rotates the quarter turn mechanism into a quarter turn receptacle disposed on the battery.

7. The electronic device of claim 5, wherein, when the locking mechanism includes the machine thread insert, an electric motor rotates the machine thread insert into a threaded insert disposed on the battery.

8. The electronic device of claim 5, wherein, when the locking mechanism includes the locking pin, a solenoid adjusts a position of the locking pin to couple with a locking pin groove disposed on the battery.

9. The electronic device of claim 1, wherein the battery arrangement is configured to re-adjust the battery during a use of the electronic device when the battery deviates from the final position.

10. The electronic device of claim 1, wherein, when the battery is received in the recess, the housing and a lid coupled to the battery are assembled to create a flush exterior of the electronic device.

11. A method, comprising:
detecting a removable battery being received at an initial position at least partially in a recess of an electronic device; and
locking, using a battery arrangement, the battery within the recess from the initial position into a final position, the battery arrangement preventing a removal of the battery until a powering down procedure of the device is completed.
automatically adjusting, using the battery arrangement, an altered position of the battery when the altered position deviates from the final position.

12. The method of claim 11, wherein the detecting is performed by a sensor that is disposed within the recess.

13. The method of claim 12, further comprising:
activating the battery arrangement upon the detecting.

14. The method of claim 12, wherein the sensor is one of a spring sensor and a light sensor.

15. The method of claim 11, wherein the locking is performed by a locking mechanism of the battery arrangement, the locking mechanism including one of a quarter turn mechanism, a machine thread insert, and a locking pin.

16. The method of claim 15, further comprising:
when the locking mechanism includes the quarter turn mechanism, rotating the quarter turn mechanism with a step motor into a quarter turn receptacle disposed on the battery.

17. The method of claim 15, further comprising:
when the locking mechanism includes the machine thread insert, rotating the machine thread insert with an electric motor into a threaded insert disposed on the battery.

18. The method of claim 15, further comprising:
when the locking mechanism includes the locking pin, adjusting a position of the locking pin with a solenoid to couple with a locking pin groove disposed on the battery.

19. The method of claim 11, further comprising:
automatically re-adjusting, using the battery arrangement, the battery when, during a use of the electronic device, the battery deviates from the final position.

20. The method of claim 11, further comprising:
creating a flush exterior for the electronic device when the battery is received in the recess through a housing of the mobile unit and a lid coupled to the battery covering the recess.

21. An electronic device, comprising:
a housing having a receiving means for receiving a removable battery; and
a battery arranging means for automatically securing the battery within the receiving means from an initial position into a final position, the battery arranging means further being configured to prevent a removal of the battery until a powering down procedure of the device is completed.
